(19) United States
(12) Patent Application Publication
(10) Pub. No.: US 2008/0017702 A1
(43) Pub. Date: Jan. 24, 2008

(54) System and Method for Conducting Electronic Account Transactions

(75) Inventors: Julian Little, Cremorne (AU); Ian Winwood McKenzie, South Yarra (AU)

Correspondence Address: FISH & RICHARDSON P.C., P.O. BOX 1022, MINNEAPOLIS, MN, 55440-1022, US

(73) Assignee: On Q Technologies Pty Ltd., Eaglemont (AU)

(21) Appl. No.: 11/691,272

(22) Filed: Mar. 26, 2007

(30) Foreign Application Priority Data
Jul. 21, 2006 (AU) 2006/903940

(51) Int. Cl. G06Q 40/00

(52) U.S. Cl. 235/379

(57) ABSTRACT

A method of performing a transfer of value from a first transaction account to a second transaction account, the transfer requested by operation of a mobile communication device operably connected to a communications network with the operation of the transaction accounts effected by an account operating system also operably connected to the communications network, the method including the steps of a user causing the generation and transmission of a transaction request from the mobile communication device to the account operating system requesting a transfer of value from the first transaction account to the second transaction account; the account operating system receiving and verifying that the transaction request from the mobile communication device is valid; and the account operating system effecting transfer of value from the first transaction account to the second transaction account.

### FIELD OF THE INVENTION

The present invention relates to a system, method, computer software program, and uses thereof, for conducting transactions with respect to transaction accounts, the operation of which are effected by an account operating system that receives requests from mobile communication devices connected to a communications network.

### BACKGROUND IF THE INVENTION

Increasingly, users seek to operate their financial arrangements in the most convenient manner without the requirement to attend a physical premises to effect a financial transaction. This is evidenced by the significant increase in users settling their accounts or invoices electronically by transferring funds from an existing bank account to the party to whom a debt is owed.

In this regard, “on-line” banking has arisen enabling users to pay bills and attend to settling invoices outside banking hours by accessing their funds on-line and effecting transfer of funds from their bank account to pay the outstanding debt. This is usually effected by a user accessing a website on a home computing workstation or accessing an Interactive Voice Response (IVR) system to direct the transfer of funds from their account to the account of an entity to whom a debt is owed.

However, users still find that it is necessary to attend a physical premises of their banking institution or an Automatic Teller Machine (ATM) in instances where they require cash as a large number of transactions are only able to be effected with the transfer of cash. For example, purchasing low cost items from a convenience store or settling a personal debt with another individual usually requires a cash transaction as the entity to whom the debt is owed in these instances either does not have an electronic bank account into which funds may be deposited or the costs associated with operating an electronic bank account for such transactions does not warrant the use of such a facility for the purchase of low cost items. In these instances, the transaction charge levied by the bank for conducting such a transaction usually renders the use of these transaction facilities as not commercially viable as the transaction charge substantially exceeds the profit margin of the item available for purchase. Further, settlement of person to person payments by use of bank accounts is not typically used as most people are reluctant to exchange or provide bank account details for security and privacy reasons. With the increasing incidence of identity theft, providing another person with bank account details can enable them to supplement this information with information gathered from other sources to fraudulently gain access to the bank account.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

### Method of the Invention

In one aspect, the present invention provides a method of performing a transfer of value from a first transaction account to a second transaction account, the transfer requested by operation of a mobile communication device operably connected to a communications network with the operation of the transaction accounts effected by an account operating system also operably connected to the communications network, the method including the steps of:
(a) a user causing the generation and transmission of a transaction request from the mobile communication device to the account operating system requesting a transfer of value from the first transaction account to the second transaction account;
(b) the account operating system receiving and verifying that the transaction request from the mobile communication device is valid; and
(c) the account operating system effecting transfer of value from the first transaction account to the second transaction account.

In an exemplary embodiment, the mobile communication device is a mobile phone, sometimes referred to as a cell phone in some countries, although other alternatives such as personal digital assistants, or other portable computing devices that may be operably connected to a communications network would suffice. In one embodiment, a mobile phone is used as the mobile communication device and transmits transaction requests by SMS (Short Message Service).

In this exemplary embodiment, the mobile phone is associated with the first transaction account which belongs to the user and upon transmitting an SMS message to the account operating system, the user's mobile phone number is also transmitted and used by the account operating system to identify the first transaction account.

In addition to receiving the transaction request transmitted by SMS, in an exemplary embodiment, the account operating system also verifies that the transaction request is valid. The extent to which a transaction request is verified may vary depending upon the embodiment and the extent to which the account operating system implements account security. However, in one exemplary embodiment, the validity of a transaction request at least includes determining the balance of the first transaction account to determine whether there is sufficient value in the transaction account to be transferred to the second transaction account.

In one embodiment, data pertaining to the second transaction account, to which value is to be transferred, is stored with the details of the first transaction account by the account operating system. In this embodiment, when a user transmits a transaction request, they only need to indicate the request and the amount to be transferred as the details of the second transaction account is already stored and associated with the first transaction account.

In other embodiments, the user may pre-identify a range of second transaction accounts to which they would prefer to be able to transfer value and in this instance, the transaction request would need to indicate the particular second transaction account to which value should be transferred. In some embodiments, the verification of the transaction request includes determining the existence of a valid second transaction account before effecting the transfer of value between the accounts.

In further embodiments, a user may perform an ancillary action that requires a transfer of value from a first transaction account to a second transaction account and the transfer occurs as part of the users' operations that perform ancillary action. For example, in one embodiment, a competition is conducted whereby a prize is offered for the correct answer to a question. Users who qualify to enter the competition may then transmit an SMS to the telephone number of the competition holder with their answer to the competition question. At the time of performing the action to transmit an SMS to the competition holder, the communication device sends a request to transfer value from a transaction account associated with the communication device to a transaction account owned by the competition holder. The amount of the transfer value may be pre-programmed into the communication device during installation of the telephone number of the competition holder or alternatively, the transfer of value could be managed by the competition holder.

For example, a user wishing to submit entries to a competition may download an application for execution on their mobile communication device (e.g. a java applet) which includes the relevant telephone number of the competition holder and the amount to be transferred from the transaction account associated with the user's mobile communication device to the competition holder's account. The downloaded executable application may prompt the user for the answer to be submitted for the competition and may not require any further input. Alternatively, the user may be prompted for a personal identification number (PIN), or any other security requirement (e.g. biometric), to authorise the transfer of funds

In any event, the user effectively causes the value transfer whilst performing another action, the transfer occurring automatically and not requiring specific user involvement.

In addition to the mobile communication device, the transaction accounts may be associated with another device such as a swipe card or similar, thus enabling the users of transaction accounts to load value into the accounts with commonly available mechanisms such as depositing cash in an Automatic Teller Machine (ATM) or any other arrangement that enables a user to load value into a transaction account. Of course, in the event that a commonly available mechanism to load value into a transaction account is provided by use of the mobile communication device, it is unlikely that there would be a need for another device for this purpose.

Value retained in a first transaction account may be transferred to a second transaction account for a range of purposes including transferring funds to another user as a gift, settlement of a debt, payment for a service or alternatively, where the second transaction account belongs to a provider of goods, the transfer could be effected to purchase available goods.

The value in the transaction accounts could be any tradable currency including the local currency, a foreign currency or even points or some other measure of value.

In some embodiments, a record of transactions in relation to all the transaction accounts are retained and the method of the transaction is also recorded thus providing a user with a complete history of the transactions pertaining to any particular account. Further, in accordance with regular account practices, it is preferable that an up to date balance for each account is retained for ready access by a user. In one embodiment, account balances are obtained by the user transmitting an SMS message to a system provider requesting an account balance and subsequently receiving an SMS message indicating the balance of the account.

In another aspect, the present invention provides a method of obtaining a balance of a transaction account, the method including the steps of:
(a) a user generating and transmitting a transaction account balance request from a mobile communication device to an account operating system;
(b) the account operating system receiving and verifying that the balance request from the mobile communication device is valid; and
(c) the account operating system obtaining the value balance of the transaction account and generating and transmitting a balance response including the balance information.

In an exemplary embodiment, an account balance request is generated and transmitted in the same manner, and using the same mechanism, as a transaction request.

### System of the Invention

In another aspect, the present invention provides an account operating system for performing transaction account operations including transfers of value from source transaction accounts to destination transaction accounts, transfer requests being transmitted to the account operating system by operation of a mobile communication device operably connected to a communications network, the system including:
(a) a data receiving means operably connected to the communications network for receiving transaction requests;
(b) a data analysis means for extracting relevant information from any received data to determine the details of the transaction request and a unique identification number pertaining to the mobile communication device from which the transaction request was received;
(c) a database for storing account details and unique identification number(s) of any mobile communication devices that are associated with, and authorised to operate, accounts;
(d) a verification means operable to receive the details of a transaction request and interrogate the database to verify the transaction request; and
(e) a transfer effecting means to process the transaction request in the event that a transaction request is verified, the transfer thus debiting the source account and crediting the destination account.

In an exemplary embodiment, the system provides notification to the owner's (or authorised operators) of the source and destination accounts to confirm the details of any transaction affecting those accounts. Depending upon the preference of the owner's (or authorised operators) of the accounts, the confirmation of transaction details could be transmitted to them by SMS, MMS, email or any other alternative messaging arrangement that is preferred by the users.

In one exemplary embodiment, the verification means ensures that the transaction request can only be effected if the source account has sufficient funds such that it remains in credit (or has a nil balance) subsequent to the requested transaction. Of course, such verification can also take into account any transaction fees that are levied by the account operating system and/or any requirements to maintain a minimum balance in the account. In this embodiment, the account system operator should always have an overall positive account balance with respect to all the value retained in the user transaction accounts. In another exemplary embodiment, all the value retained in the user transaction accounts are pooled into one or more separate accounts by the account system operator for convenience of operation. In an exemplary embodiment, a single bank account is used to retain the pooled cash value of all the accounts. As compared with a banking system, the present invention embodies the advantage of avoiding the requirement for a separate bank account for each user. Additionally, where the present invention is operated across international boundaries, the invention avoids the requirement for inter bank cooperation or inter bank operating procedures for the transfer of value from one transaction account to another. According to present arrangements, where inter bank transactions are requested, there are usually substantial fees incurred on a transaction basis which can make relatively small transactions between accounts commercially non-viable.

### Computer Software Program Code for Implementing the Method of the Invention

In another aspect, the present invention provides a computer program enabling a user to access and perform transaction account operations including effecting a transfer of value from a source transaction account to a destination transaction account, the request to effect the transfer of value being generated and transmitted by a mobile communication device operably connected to a communications network, the computer program including:

computer instruction code for receiving transaction requests from a user's mobile communication device;

computer instruction code for determining a unique identification number of the mobile communication device and the details of the transaction request;

computer instruction code for identifying the relevant transaction account associated with the mobile communication device and subject of the transaction request and verifying the transaction request; and

computer instruction code for effecting the transfer of value from the source account to the destination account in the event that the transaction request is successfully verified.

The computer instruction code may result in computer instructions that are implemented integrally to a computer or of a network of computers using separate software components. The code may also include components of existing software that effect functions in cooperation with dedicated code developed specifically for the present invention.

### Mobile Communications Device

In yet another aspect, the present invention provides a mobile communication device when used for effecting transaction account operations including a transfer of value from a source transaction account to a destination transaction account, the mobile communications device being operably connected to a communications network, the mobile communication device operable to effect the steps of:
(a) generating a transaction request to transfer value from a source account to a destination account; and
(b) transmitting the transaction request in the form of a data message according to a protocol that is acceptable to the communications network.

### BRIEF DESCRIPTION OF THE DRAWINGS

Exemplary embodiments of the invention are now described with reference to the accompanying drawings, in which:

FIG. 1 is a diagrammatic representation of the primary system components of an embodiment of a system operable to effect the method according to the present invention;

FIG. 2 is a diagrammatic representation of the primary system components of an embodiment of a system operable to transfer value from an account of a first user to an account of a second user;

FIG. 3 is a flowchart detailing the method steps associated with the transfer of value from an account of a first user to an account of a second user (referred to as an inter-account transfer);

FIG. 4 is a flowchart detailing the steps of an embodiment of the invention associated with the establishment of a competition and in particular, the procedure of establishing eligible entrants;

FIG. 5 is a flowchart detailing the steps of an embodiment of the invention associated with conducting a competition, receiving entries and awarding prizes to winners.

### DETAILED DESCRIPTION OF THE EXEMPLARY EMBODIMENTS

Throughout the description of exemplary embodiments of the invention, there are numerous references to effecting transactions by use of SMS messaging as this arrangement is presently one of the most widely available arrangements for conveniently transmitting data at a reasonable cost. Of course, as will be recognised by persons skilled in the relevant field of technology, the SMS arrangement may be superseded by widespread implementation of alternative data messaging arrangements that provide similar or improved data entry and transmission arrangements as compared with SMS. For example, WAP (Wireless Access Protocol) or IP Messaging for handheld/portable devices may eventually provide similar data transmission capabilities with improved user interfaces as compared with SMS text via mobile phone for a cost that renders SMS messaging obsolete. Therefore, although the exemplary embodiments include references to the use of SMS messaging it should be recognised that any alternative data messaging arrangement could equally be used for the purpose of implementing the invention.

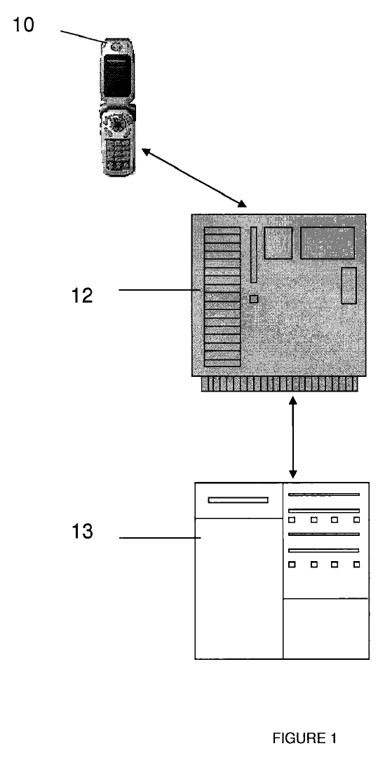

FIG. 1 is a diagrammatic representation of the primary system components of an embodiment of an account operating system according to the present invention. With reference to FIG. 1, a user gateway server (12) is provided as an interface for users with transaction accounts that are accessible by operation of a mobile communication device (sometimes referred to as “on-line” accounts). These accounts are maintained and operated by an account operating system.

The user gateway server (12) provides connectivity to mobile communication devices (10) such as a mobile telephone or personal digital assistant. The mobile communications device (10) is connected to the system to allow the user of the mobile communications device (10) to effect transactions involving on-line electronic accounts that are administered by the system. An account system server (13) provides the online account system services such as the maintaining of account balances and the effecting of transfers of value between accounts. Data storage devices [not shown] are associated with the account server (13) to store the account details of all of the users and any links between multiple accounts. The account server (13) further includes logic and rules servers [not shown] which process all requested transactions from the mobile communications devices (10).

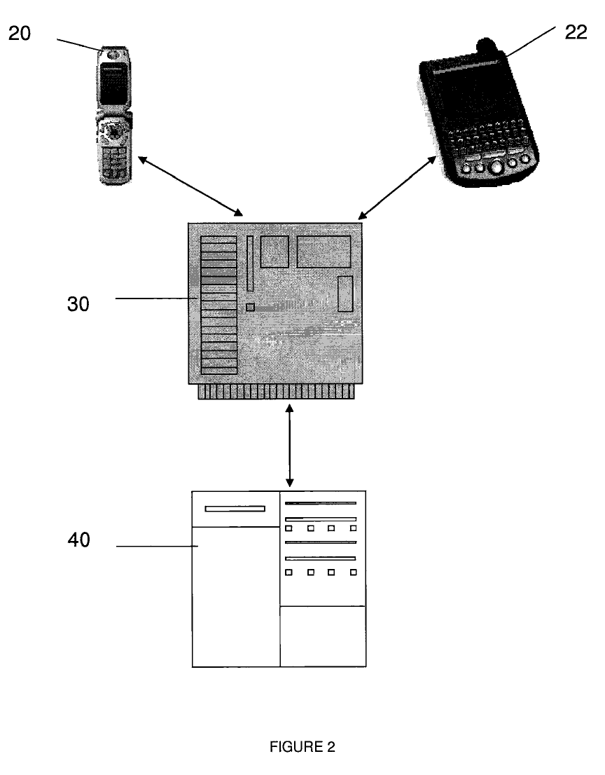

With reference to FIG. 2, operation of the system associated with an inter-account transfer is described where a user of a mobile phone (20) may transfer funds from an account to the account of another user who operates a mobile computing device (22).

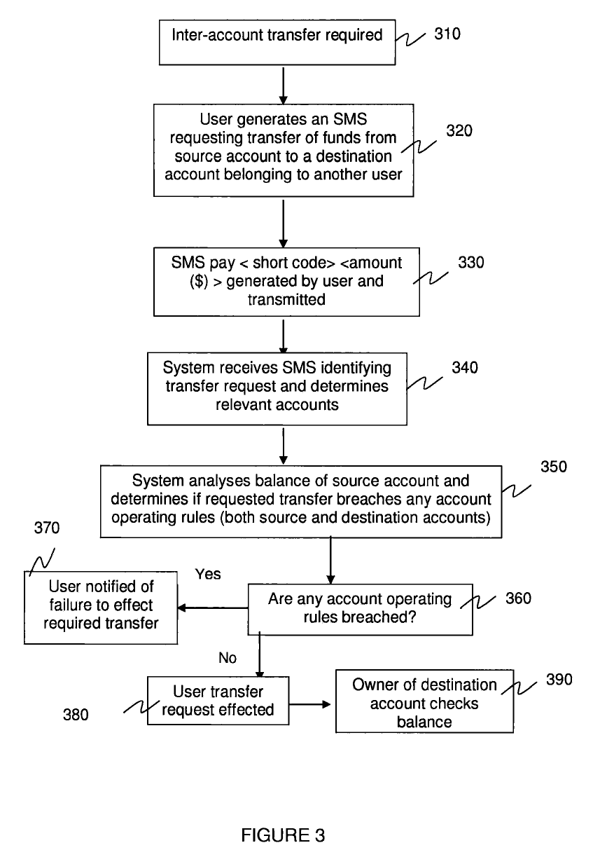

In operation, the user [not shown] of the mobile phone (20), generates a transaction request from the mobile phone (20) and transmits same to the user gateway server (30). The transaction request is made by utilising a message transfer system associated with the mobile phone (20). The message transfer system may be short message service (SMS), multimedia message service (MMS) or a service provided by Wireless Application Protocol (WAP). The user transmits a transaction request from the mobile phone (20) and the transaction request is received by the user gateway server (30) which forwards the transaction request to the account system server (40). The account system server (40) verifies the request from the user of the mobile phone (20) as is described in further detail with reference to FIG. 3. Once the transaction request has been verified, the account system server (40) then conducts the transaction by arranging for a transfer of value from an account associated with the mobile phone (20) to another account as per the transaction request.

Once the transfer has been completed, the account system server (40) generates a transaction confirmation from the transaction account to the mobile phone (20). The transaction confirmation is made by utilising a message transfer system. The message transfer system may be short message service (SMS) or multimedia message service (MMS).

The account to which the value transfer has been made is associated with a mobile computing device (22) such that once the transaction has been completed, the account system server (40) generates a confirmation message and transmits same through the gateway (30) to the mobile computing device (22) associated with an account to which value has been transferred.

### Examples of Operation of System

With reference to FIG. 3, the method steps associated with an inter-account transfer are detailed wherein a user may transfer funds from a transaction account to the account of another user. In some embodiments, the first transaction account from which value is to be transferred is not owned by the user but sufficient access authority has been previously established to enable them to effect a transaction request.

At step 310, a user determines the requirement for an inter-account transfer to another entity with whom they have a pre-existing transfer arrangement. For example, a user may need to pay for the services of a babysitter or a handyman and they discover that they do not have any ready cash available. In these instances, the user may elect to transfer funds from an on-line account to the on-line account of the other entity.

In the example of FIG. 3, at step 320, the user generates an SMS message requesting transfer of funds from a source account owned by the user to a destination account belonging to another user. At step 330, the SMS message “Pay <Short-code> <amount ($)>” is generated and transmitted by the user to the on-line account operating system. At step 340, the gateway of the on-line account system receives the SMS message identifying the transfer request and determines the relevant account from the SMS message. In the example of FIG. 3, the <short-code> identifies the user to whom funds will be transferred and the <amount ($)> identifies the value to be transferred. The user seeking to transfer funds is identified by the mobile phone number from which the SMS message is transmitted to the system and in the event that a particular source account is not identified in the SMS message a default account is assumed as the source account from which funds will be transferred.

At step 350, the on-line account system verifies the transaction request by analysing the balance of the source account and determining whether the requested transfer of funds can be effected.

Step 360 determines the course of action to follow depending upon whether or not the transaction request has been verified. In the event that the transaction requests fails the verification test(s), the method proceeds to step 370 where the user is notified of the failure to effect the requested transfer. However, in the event that verification of the transaction request is successful, the method proceeds to step 380 where the user requested transaction is effected and subsequent to the transfer, the owner of the destination account may check their balance to verify the receipt of value (step 390). In this instance, the owner of the destination account may transmit an SMS message to the account operating system such as, Bal <short code>, to determine the balance of their account where the <short code> identifies the destination account. Of course, the facility to retrieve an account balance would be useful for all account owners but would most likely be particularly useful for destination account owners to check the receipt of transferred value.

In addition to “Pay” and “Bal” instructions other exemplary embodiments include other account operating instructions such as “Last”, to obtain a report of the last transaction that is recorded in the account or “Last <short code> <number>” where the <short code> identifies the person or entity relevant to the transactions of interest to the user and the <number> field identifies the number of the last transactions relevant to the person or entity. These latter account operating instructions could be particularly useful for users wishing to obtain a listing of the last few transactions that relate to a particular person or entity to ensure that they have paid a required value.

In yet another exemplary embodiment, to improve account operating security, accounts may be established in an initially inactive state and await transmission of an activation instruction in the form of an SMS message “Act <short code>” where <short code> identifies the user's account. Further, in the event that an account is likely to be inactive for a relatively lengthy period, a user may prefer to deactivate the account with the transmission of a “Deact <short code>” SMS message to render the account deactivated and thus causing any verification of a transaction involving the account to fail. This facility may provide users with an increased feeling of security in the knowledge that their account cannot be accessed by any party during periods of deactivation.

In the exemplary embodiment of FIG. 3, the <short code> relates to another user for whom a pre-existing arrangement has been established. However, in alternative exemplary embodiments, a transfer of value from one user to another user on an ad-hoc basis may be useful.

This latter situation could arise where a user needs to make a single payment to another entity and did not have any significant advance warning of the requirement. For example, if a user requires a personal loan in the form of cash, they may need to transfer funds to the person from whom they are obtaining the cash from. Another example would be the instance where a user needs to pay for the services of a babysitter or a handyman that was required at short notice and they discover that they do not have any ready cash available to pay for their services. In these instances, the user may elect to transfer funds from one of their on-line accounts to the on-line account of the other person or entity.

Whereas the <short code> may be used as an abbreviation for a person or entity with which a user has a pre-existing relationship, this code could be replaced with various numbers or means by which to identify a destination account to which a user wishes to transfer value. For example, a destination account could be identified by a Visa number, a mobile phone No or a unique account number ascribed by the account system operator. The identification could be direct (i.e. the account number is the Visa No, mobile phone No etc) or the identification could be indirect (i.e. where the account is associated with a Visa No, mobile phone No etc).

In any event, any of the above described means could be used to effect a transfer of value to another person or entity on an ad-hoc basis upon the owner, or authorised user, of a destination account providing the relevant destination account identification details to the owner, or authorised user, of the source account. Further, in alternative exemplary embodiments, the collection of the destination account identification details may be effected by an electronic data acquisition process such as an RFID reader acquiring the identification details of a tag or a bar code reader or magnetic swipe reader capturing the details of a bar code or magnetic swipe card. Of course, this would depend upon the particular device that is used to identify accounts within the account system.

Of course, whilst transferring funds between transaction accounts according to the present invention enables such transfers to occur with relative ease and convenience for account owners, some consumers may be concerned that funds could be withdrawn from their account(s) without their authorisation.

Accordingly, in one embodiment, in order to transfer funds from a user's transaction account, it is necessary to enter a PIN, or other form of identification indicia, to enable the transfer to occur. For example, a requested transfer may cause an automated call to the user's mobile communications device that requests the PIN from the user before allowing the transfer to occur. In this instance the automated call would most likely be initiated by an IVR (Interaction Voice Response) system and, the cost of the automated call would be added to the overall cost of effecting the transfer of funds.

Alternatively, in another embodiment, users may download an application that executes on their mobile communication device that requests their PIN each time a transaction is requested. In this embodiment, the PIN may be encrypted before being transmitted to the host along with the request to transfer funds.

In embodiments with the “security feature” requiring a PIN, or other form of identifying indicia, users may set the transaction amount for which the “security feature” is required. Some users may require a relatively low transaction amount (e.g. $50 or above) to be “secured” in order to feel sufficiently confident to use the system whereas others may be comfortable with a relatively high transaction amount (e.g. $500 or above) before requiring the invocation of a “security feature” to ensure the bona fides of the user requesting the transfer. The transaction amount for which the “security feature” is invoked is preferably set by a user either by accessing a web-site and entering the transaction amount or by sending the amount via an SMS message.

In one particular embodiment of the invention, a competition is conducted by a competition holder where there is a cost associated with the submission of an entry and the winner, or winners, receive a transfer of value from an account to the winners transaction accounts.

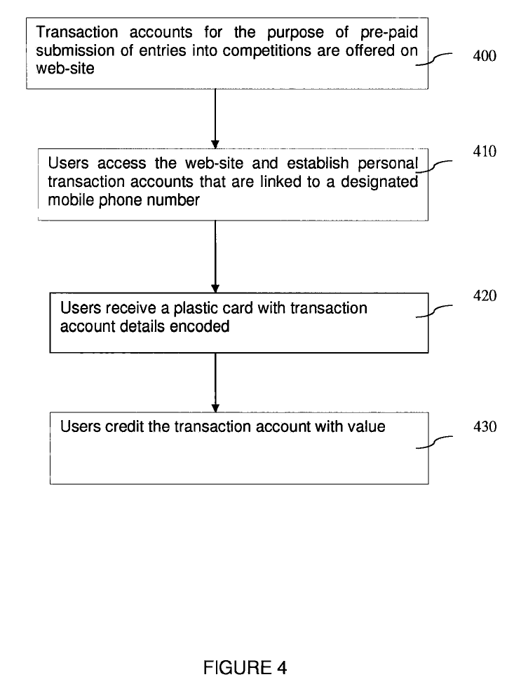

With reference to FIG. 4, in the particular embodiment of a competition described in this specification, to be eligible to enter a competition, it is necessary to have a transaction account that is established by the competition holder (Step 400). The transaction accounts established at step 400 are specifically for the purpose of submitting entries into competitions and the offer to establish a transaction account for the purpose of entering competitions may be offered and arranged on a website.

At Step 41 0, users access the website and establish their own personal transaction accounts that are linked to a mobile phone number designated by the user. Having established an account, and satisfying the necessary identification requirements that may also be imposed by a competition holder, an account identification means such as a plastic card that has the transaction account details encoded upon it, is sent to the user (Step 420). In an embodiment of the invention, the transaction account identification means is transmitted to the user by post but may also be sent by courier.

Having received a plastic card with the transaction account details encoded upon it, users may credit the transaction account (Step 430) with value by a range of means. For example, they may transfer value to their competition transaction account by the transfer of value from another pre-existing account. In any event, users will be aware of the requirement for the account to have a minimum value balance in order to submit entries into competitions conducted by the competition holder.

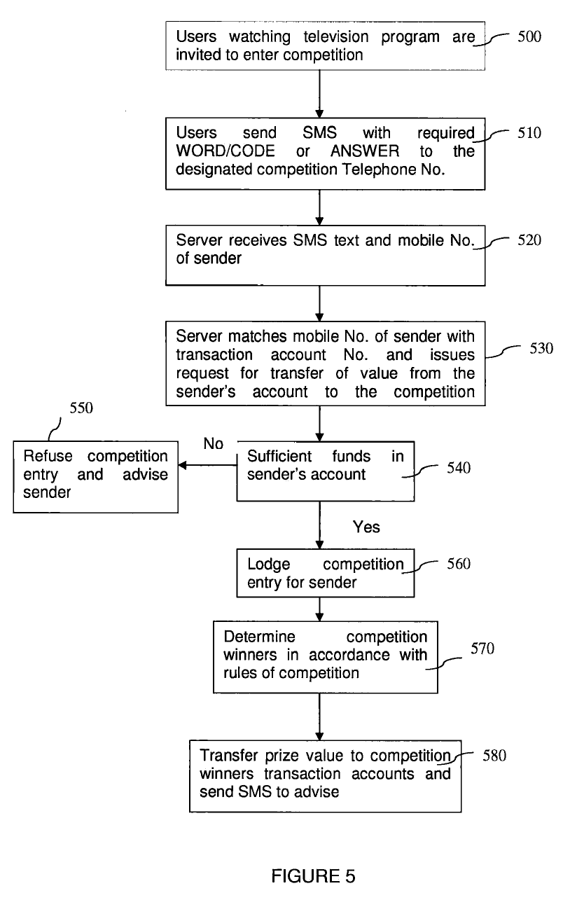

With reference to FIG. 5, the specific example of a competition conducted during a television program is detailed wherein, at Step 500, users watching a television program are invited to enter a competition. Of course, the competition holder may restrict the entry of submissions into the competition to only those with a pre-established transaction accounts with the competition holder.

In the particular example of FIG. 5, the competition requires entrants to submit an SMS message to a designated telephone number with a particular word included in the message. Upon receiving this information from the television program, users wishing to enter the competition transmit an SMS message with the required WORD to the designated competition telephone number (Step 510).

The competition holder has a server that receives the SMS text along with the mobile number of the sender (Step 520). Of course, having established the transaction account for the user and linking same with a designated mobile phone number, the competition holder is able to determine from the mobile telephone number in the SMS text message the particular transaction account of the sender of the message. Therefore, at Step 530, the server matches the mobile number of the sender with the relevant transaction account number and issues a request for a transfer of value from the sender's transaction account to the competition holder's transaction account. The cost associated with submitting an entry would also be advertised during the television program and as a result, users would have forewarning of the value required in their transaction account in order to submit a competition entry.

Accordingly, at Step 540, the server that issues the request for a transfer of value from the sender's transaction account to the competition holder's transaction account determines whether sufficient funds are available in the sender's transaction account in order to submit a valid competition entry. In the event that the request for a transfer of value is refused (Step 550), then it is clear that the sender's transaction account does not have sufficient funds for the purpose of submitting a valid entry into the competition and the user's entry is not included.

However, in the event that the user's transaction account has sufficient funds for a valid competition entry, the method proceeds to Step 560 wherein the user's entry is lodged as a valid entry subsequent to the transfer of the necessary value from the senders transaction account to the competition holder's transaction account.

The method Steps from 500 to 560 are effectively repeated for each and every submission of an entry into the competition by users. Of course, during the television program, there may be many entries submitted by many different users and also, there may be numerous entries by a single user. In any event, the competition will be of limited duration and ultimately, the time in which to submit valid competition entries will expire and the server will no longer receive competition entries in the form of text messages.

At Step 570, at the completion of the competition, the competition holder determines the winners in accordance with the rules of the competition and at Step 580, the competition holder transfers value to the transaction accounts of the competition winners and transmits an SMS message to advise those winners of the transfer of value to their transaction accounts.

The embodiment of the invention detailed in FIGS. 4 and 5, provide a significant improvement to the conduct of competitions conducted via mass-media. For example, it is usually a relatively difficult process to levy a charge or fee for the submission of an entry and to be able to receive a transfer of value from the competition entrant to the competition holder at the time of receiving the competition entry. Further, it is also usually difficult to be able to supply competition winners with their prize in the form of a transfer of value to a transaction account relatively shortly after the cessation of the competition. In the particular embodiment described in FIGS. 4 and 5, in addition to receiving a transfer of value at the time of receiving an entrant's submission, the competition holder is able to award prizes in the form of transferring value to individual user's transaction accounts virtually immediately upon expiry of the time allowed for the submission of entries. As a result, it is perceivable that competition winners could receive their prizes before the end of the television program conducting the competition. Further, this particular embodiment does not require competition entrants to collect their prizes by attending a nominated location or necessitating the provision of bank account details to allow the deposit of a cash prize. As an additional benefit, the transaction account may be used to account for value other than cash and may, for example, be used to accumulate some other form of value such as points that may be awarded for the purchase of certain types of goods with the use of certain services. Upon receiving a sufficient number of points, users may then be eligible to enter competitions conducted by the competition holder and the cost of submitting an entry would be debited from the user's transaction account according to the number of points required to submit a valid competition entry.

Of course, as soon as a competition prize is transferred into a user's transaction account, the prize winnings may be used for other purposes and when the prize awarded is in the form of cash, the funds are immediately available upon the transfer to the user's transaction account and those funds may be accessed by transferring them to another account from which a withdrawal from an automatic teller machine, or any collaborating operator of a Point of Sale (POS) device, may occur. Alternatively, in some embodiments, the competition holder's established transaction account may enable the user to direct the access funds from an automatic teller machine.

In addition to all the other benefits described above, the flexibility of the embodiment described in FIGS. 4 and 5 enables competition holders to award a relatively large number of prizes whilst incurring a similar transaction fee as compared with awarding one large prize. Such an embodiment also provides a competition holder with the ability to promote the use of the competition holder's transaction accounts (by limiting eligibility of competition entrants to only those with a valid transaction account designated by the competition holder) and a range of additional marketing opportunities arise as a result of limiting competition entrants to only those that hold a valid transaction account operated by the competition holder.

Of course, in alternative embodiments of a competition or event that allows voting, it is possible that transaction accounts already in existence (i.e. not created by the competition holder) may be used for the purpose of paying for entries. In such an embodiment, transaction accounts may have been established and managed by another entity. In this instance, where transaction accounts have already been established for a range of consumers that substantially match the target demographic audience for a competition or event holder, it may be preferable for the competition/event holder to enter into an arrangement with the entity that establishes and manages the transaction accounts to avail themselves of the transaction account infrastructure already established. Of course, as consumers without transaction accounts become aware of the competition/event and wish to submit entries, they may contact the entity responsible for the establishment and management of transaction accounts to arrange such an account thus enabling them to submit entries to the competition/event.

In another embodiment, details of existing transaction account owners may be made available to competition holders to better enable them to develop competitions and events of interest to the owners of transaction accounts.

As the present invention may be embodied in several forms without departing from the essential characteristics, it should be understood that the above described embodiment should not be considered to limit the present invention but rather should be construed broadly within the spirit and scope of the invention. Accordingly, various modifications and equivalent arrangements are intended to be included within the spirit and scope of the invention.

1. A method of performing a transfer of value from a first transaction account to a second transaction account, the transfer requested by operation of a mobile communication device operably connected to a communications network with the operation of the transaction accounts effected by an account operating system also operably connected to the communications network, the method including:
(a) a user causing the generation and transmission of a transaction request from the mobile communication device to the account operating system requesting a transfer of value from the first transaction account to the second transaction account;
(b) the account operating system receiving and verifying that the transaction request from the mobile communication device is valid; and
(c) the account operating system effecting transfer of value from the first transaction account to the second transaction account.

2. The method of claim 1, wherein the method further includes:
(d) generating a transaction confirmation message in the event of a verified transaction and transmitting same to the user's mobile communication device.

3. The method of claim 2, wherein the method further includes:
(e) generating a transaction confirmation message in the event of a verified transaction and transmitting same to a mobile communication device associated with the account to which value has been transferred.

4. The method of claim 3, wherein the transaction request and transaction confirmation is in the form of a message transfer.

5. The method of claim 3, wherein the transaction request and transaction confirmation is in the form of a short message service (SMS).

6. A method according to claim 1 wherein the verification that the transaction request from a mobile communication device is valid includes determining the balance of the first transaction account to determine whether there is sufficient value in the transaction account to be transferred to the second transaction account and where the transfer of value from the first transaction account to the second transaction account only occurs in the event that a valid indication results from the verification.

7. A method according to claim 1 wherein data pertaining to the second transaction account to which value is to be transferred is stored with details of the first transaction account in the account operating system such that a user may transmit a transaction request wherein the user is only required to initiate the request and provide data pertaining to the value to be transferred.

8. A method according to claim 1 wherein the user performs an ancillary action that causes the generation and transmission of a transaction request from the mobile communication device to the account operating system.

9. A method according to claim 8 wherein the ancillary action includes the generation and transmission of a message for the purpose of submitting an entry into a competition or providing a message wherein a fee is levied for the receipt and recordal of such a message.

10. A method according to claim 8 wherein an executable application is installed on the user's mobile communication device to enable the user to perform the ancillary action and which generates and transmits a request from the mobile communication device to the account operating system to transfer value from the first transaction account to a second transaction account wherein at least some of the data required for the transaction request is included in the executable application.

11. A method according to claim 1 wherein verifying the transaction request from the mobile communication device includes the issuance of a request for a personal identification number, or other form of identification indicia, from the operator of the mobile communication device said verification resulting an indication of a valid transaction request in the event that the personal identification number, or other form of identification indicia, matches the pre-stored personal identification number or other form of identification indicia accessible to the account operating system.

12. A method of obtaining a balance of a transaction account, method including:
(a) a user generating and transmitting a transaction account balance request from a mobile communication device to an account operating system;
(b) the account operating system receiving and verifying that the balance request from the mobile communication device is valid; and
(c) the account operating system obtaining the value balance of the transaction account and generating and transmitting a balance response including the balance information.

13. A method according to claim 12 wherein the balance response is transmitted to the mobile communication device associated with the transaction account for which a balance was requested.

14. An account operating system for performing transaction account operations including transfers of value from source transaction accounts to destination transaction accounts, transfer requests being transmitted to the account operating system by operation of a mobile communication device operably connected to a communications network, the system including:
(a) a data receiving means operably connected to the communications network for receiving transaction requests;
(b) a data analysis means for extracting relevant information from any received data to determine the details of the transaction request and a unique identification number pertaining to the mobile communication device from which the transaction request was received;
(c) a database for storing account details and unique identification number(s) of any mobile communication devices that are associated with, and authorised to operate, accounts;
(d) a verification means operable to receive the details of a transaction request and interrogate the database to verify the transaction request; and
(e) a transfer effecting means to process the transaction request in the event that a transaction request is verified, the transfer thus debiting the source account and crediting the destination account.

15. A system according to claim 14 wherein notification is provided to the owners of the source and destination accounts to confirm the details of transactions involving those accounts.

16. A system according to claim 15 wherein the notification is provided by transmission of any one or more of the following:
SMS;
MMS; or
Electronic mail message.

17. A system according to claim 14 wherein the verification means ensures that the transaction request can only be effected if the source account has sufficient funds such that it remains in credit subsequent to effecting the requested transaction.

18. A system according to claim 17 wherein the verification also takes into account any transaction fees that are levied by the account operating system as a result of effecting the requested transaction.

19. A system according to claim 14 wherein the value of all the user transaction accounts is pooled into a single account by the account system operator.

20. A system according to claim 19 wherein the value in user transaction accounts relates to monetary value and all cash deposits are pooled into a single account operated by a financial institution.

21. A computer program enabling a user to access and perform transaction account operations including effecting a transfer of value from a source transaction account to a destination transaction account, the request to effect the transfer of value being generated and transmitted by a mobile communication device operably connected to a communications network, the computer program including:
computer instruction code for receiving transaction requests from a user's mobile communication device;
computer instruction code for determining a unique identification number of the mobile communication device and the details of the transaction request;
computer instruction code for identifying the relevant transaction account associated with the mobile communication device and subject of the transaction request and verifying the transaction request; and
computer instruction code for effecting the transfer of value from the source account to the destination account in the event that the transaction request is successfully verified.

22. A mobile communication device when used for effecting transaction account operations including a transfer of value from a source transaction account to a destination transaction account, the mobile communications device being operably connected to a communications network, the mobile communication device operable to effect the steps of:
(a) generating a transaction request to transfer value from a source account to a destination account; and
(b) transmitting the transaction request in the form of a data message according to a protocol that is acceptable to the communications network.

23. A method according to claim 1 wherein the mobile communication device includes any one or more of the following:
a mobile phone;
a cell phone; and/or
a personal digital assistant; and/or
any communications enabled portable computing device.

24. A method according to claim 1 wherein a transaction account is also associated with another device including a magnetic swipe card.

25. A method according to claim 24 wherein the use of the associated additional device is used to access value from the transaction account by use of the additional device at an automatic teller machine or any collaborating operator of a point of sale (POS) device.

26. A method according to claim 1 wherein the value in the transaction accounts is any one of the following:
local currency;
foreign currencies;
frequent flyer points;
merchant loyalty points; or
any points scheme that may be traded for goods and/or services.

27. A method according to claim 1 wherein a record of transactions with respect to transaction accounts is maintained and reported to the owner of the transaction account.

28. A method according to claim 12 wherein the mobile communication device includes any one or more of the following:
a mobile phone;
a cell phone;
a personal digital assistant; and/or
any communications enabled portable computing device.

29. A system according to claim 14 wherein the mobile communication device includes any one or more of the following:
a mobile phone;
a cell phone;
a personal digital assistant; and/or
any communications enabled portable computing device.

30. A computer program according to claim 21 wherein the mobile communication device includes any one or more of the following:
a mobile phone;
a cell phone;
a personal digital assistant; and/or
any communications enabled portable computing device.

31. A mobile communications device according to claim 22 wherein the mobile communication device includes any one or more of the following:
a mobile phone;
a cell phone;
a personal digital assistant; and/or
any communications enabled portable computing device.

32. A method according to claim 12 wherein a transaction account is also associated with another device including a magnetic swipe card.

33. A system according to claim 14 wherein a transaction account is also associated with another device including a magnetic swipe card.

34. A computer program according to claim 21 wherein a transaction account is also associated with another device including a magnetic swipe card.

35. A mobile communications device according to claim 22 wherein a transaction account is also associated with another device including a magnetic swipe card.

36. A method according to claim 32 wherein the use of the associated additional device is used to access value from the transaction account by use of the additional device at an automatic teller machine or any collaborating operator of a point of sale (POS) device.

37. A system according claim 33 wherein the use of the associated additional device is used to access value from the transaction account by use of the additional device at an automatic teller machine or any collaborating operator of a point of sale (POS) device.

38. A computer program according to claim 34 wherein the use of the associated additional device is used to access value from the transaction account by use of the additional device at an automatic teller machine or any collaborating operator of a point of sale (POS) device.

39. A mobile communication device according to claim 35 wherein the use of the associated additional device is used to access value from the transaction account by use of the additional device at an automatic teller machine or any collaborating operator of a point of sale (POS) device.

40. A method according to claim 12 wherein the value in the transaction accounts is any one of the following:
local currency;
foreign currencies;
frequent flyer points;
merchant loyalty points; or
any points scheme that may be traded for goods and/or services.

41. A system according to claim 14 wherein the value in the transaction accounts is any one of the following:
local currency;
foreign currencies;
frequent flyer points;
merchant loyalty points; or
any points scheme that may be traded for goods and/or services.

42. A computer program according to claim 21 wherein the value in the transaction accounts is any one of the following:
local currency;
foreign currencies;
frequent flyer points;
merchant loyalty points; or
any points scheme that may be traded for goods and/or services.

43. A mobile communications device according to claim 22 wherein the value in the transaction accounts is any one of the following:
local currency;
foreign currencies;
frequent flyer points;
merchant loyalty points; or
any points scheme that may be traded for goods and/or services.

44. A method according to claim 12 wherein a record of transactions with respect to transaction accounts is maintained and reported to the owner of the transaction account.

45. A system according to claim 14 wherein a record of transactions with respect to transaction accounts is maintained and reported to the owner of the transaction account.

46. A computer program according to claim 21 wherein a record of transactions with respect to transaction accounts is maintained and reported to the owner of the transaction account.

47. A mobile communications device according to claim 22 wherein a record of transactions with respect to transaction accounts is maintained and reported to the owner of the transaction account.
